(19) United States
(12) Patent Application Publication
(10) Pub. No.: US 2014/0016928 A1
(43) Pub. Date: Jan. 16, 2014

(54) Tone Signaling For Coherent Optical Data Receivers

(71) Applicant: Oclaro, Inc., San Jose, CA (US)

(72) Inventor: Sunil Kumar Singh Khatana, Sunnyvale, CA (US)

(21) Appl. No.: 13/940,498

(22) Filed: Jul. 12, 2013

Related U.S. Application Data
(60) Provisional application No. 61/671,430, filed on Jul. 13, 2012.

(51) Int. Cl. H04B 10/61

(52) U.S. Cl. CPC H04B 10/616
USPC 398/25

(57) ABSTRACT

A method for extracting admin information from a modulated optical signal. A coherent optical receiver receives the modulated optical signal, where a nominal carrier frequency of the modulated optical signal was modulated using a first slow frequency and second slow frequency associated with an electronic admin signal. The receiver converts the modulated optical signal to an electronic signal, and estimates estimating a plurality of carrier phases of the electronic signal. The receiver determines a plurality of offset values by calculating the time derivative of at least some of the estimated carrier phases, wherein each of the plurality of offset values are proportional to an associated frequency offset component, and the frequency of each offset value corresponds to the first slow frequency or the second slow frequency. The receiver extracts information corresponding to the electronic admin signal using the determined plurality of offset values.

### BACKGROUND CROSS-REFERENCE TO RELATED APPLICATION(S)

This application claims priority under 35 U.S.C. §119(e) to U.S. Provisional Patent Application Ser. No. 61/671,430, titled “Tone Signaling for Coherent Optical Data Receivers,” filed on Jul. 13, 2012. The subject matter of the foregoing is incorporated herein by reference in its entirety.

### BACKGROUND

1. Field of Disclosure

This disclosure is generally related to the field of coherent optical data transmission systems.

2. Description of the Related Art

Modern fiber-optic communications systems operate at data rates as high as 100 gigabits per second. Coherent optical data transmitters and receivers that are components of such communication systems carry vast quantities of data, but are not themselves privy to the meaning of that data. Customers' data may be encrypted, for example. As far as the transmitters and receivers are concerned, there is no difference between handing meaningful data and random bit streams.

Equipment operators that provide transmitters, receivers and associated subsystems find themselves in the strange predicament of having equipment sites connected by extraordinarily fast data links, yet being unable to communicate with one another via those links for mundane tasks such as channel identification or sending channel supervisory information without adding additional hardware to both the transmitter and the receiver.

### SUMMARY

In one embodiment, a coherent optical receiver performs a method for extracting a slow admin signal from a modulated optical signal. The modulated optical signal sent by a coherent optical transmitter is received. The modulated optical signal includes a high speed data signal, and the coherent optical transmitter modulated a nominal carrier frequency using an electronic admin signal using a first slow frequency and second slow frequency associated with the electronic admin signal. The modulated optical signal is converted to an electronic signal that includes a plurality of frequency offset components, and a plurality of carrier phases of the electronic signal are estimated. A plurality of offset values are determined by calculating the time derivative of at least some of the estimated carrier phases, and each of the plurality of offset values are proportional to an associated frequency offset component, of the plurality of frequency offset components, and the frequency of each offset value corresponds to the first slow frequency or the second slow frequency Information corresponding to the electronic admin signal is extracted using the determined plurality of offset values.

In another embodiment, a coherent optical transmitter modulates a laser beam from an optical source to create a modulated optical signal. The modulated optical signal includes a high speed data signal, and the coherent optical transmitter also modulates a nominal carrier frequency of the modulated optical signal using an electronic admin signal using a first slow frequency and second slow frequency associated with the electronic admin signal. The coherent optical transmitter transmits the modulated optical signal to a coherent optical receiver via an optical network. A coherent optical receiver receives the modulated optical signal, converts the modulated optical signal to an electronic signal that includes a plurality of frequency offset components, and estimates the carrier phase of the electronic signal. The coherent optical receiver determines a plurality of offset values by calculating the time derivative of the estimated carrier phase, and each of the plurality of offset values are proportional to an associated frequency offset component, of the plurality of frequency offset components, and the frequency of each offset value corresponds to the first slow frequency or the second slow frequency. Information corresponding to the slow admin signal is extracted using the determined plurality of offset values.

In yet another embodiment, a transceiver includes a coherent optical transmitter and a second coherent optical receiver. The coherent optical transmitter including an optical source configured to generate a laser beam at a carrier frequency, and a high speed modulator configured to modulate the laser with an electronic data signal to create a high speed data signal. The coherent optical transmitter also includes a source frequency modulator configured to modulate the carrier frequency of the laser beam using a first electronic admin signal to include a first slow admin signal using a first slow frequency and second slow frequency associated with the first electronic admin signal. The coherent optical transmitter is configured to transmit a first modulated optical signal that includes the high speed data signal and the first slow admin signal to a first coherent optical receiver via an optical network. The second coherent optical receiver includes an optical front end configured to receive a second modulated optical signal from a second coherent optical transmitter. The second modulated optical signal includes a second high speed data signal, and a carrier frequency of the second modulated optical signal was modulated using a second electronic admin signal using the first slow frequency and the second slow frequency associated with the second electronic admin signal. The second optical front end converts the second modulated optical signal to a second electronic signal that includes a plurality of frequency offset components. The second coherent optical receiver also includes a digital signal processing (DSP) modem configured to estimate the carrier phase of the electronic signal, and determine a plurality of offset values by calculating the time derivative of the estimated carrier phase, and each of the plurality of offset values are proportional to an associated frequency offset component, of the plurality of frequency offset components, and the frequency of each offset value corresponds to the first slow frequency or the second slow frequency. The DSP modem is also configured to extract information corresponding to the second electronic admin signal using the determined plurality of offset values.

### BRIEF DESCRIPTION OF DRAWINGS

FIG. 1 is a block diagram of an example communication system according to an embodiment.

FIG. 2A shows an example slow admin signal according to an embodiment.

FIG. 2B shows the slow admin signal of FIG. 2A in terms of frequency versus time according to an embodiment.

FIG. 3A is a block diagram of an example coherent optical receiver according to an embodiment.

FIG. 3B is a block diagram of portion of an example digital signal processing modem according to an embodiment.

FIG. 4 is an example process for detecting carrier frequency changes in a coherent optical receiver according to an embodiment.

### DETAILED DESCRIPTION

The Figures (FIGS.) and the following description describe certain embodiments by way of illustration only. One skilled in the art will readily recognize from the following description that alternative embodiments of the structures and methods illustrated herein may be employed without departing from the principles described herein. Reference will now be made in detail to several embodiments, examples of which are illustrated in the accompanying figures. It is noted that wherever practicable similar or like reference numbers may be used in the figures and may indicate similar or like functionality.

Coherent optical transceivers may send simple supervisory messages (also referred to as “admin signals”) to each other while simultaneously handling customer traffic (also referred to as “data signals”) at tens or even hundreds of gigabits per second. These supervisory messages are transmitted by frequency modulating an optical carrier in a coherent optical transmitter and detecting the frequency modulation in an optical receiver. The supervisory messages are sent at rates that are negligible compared to the data rate of simultaneously transmitted customer data.

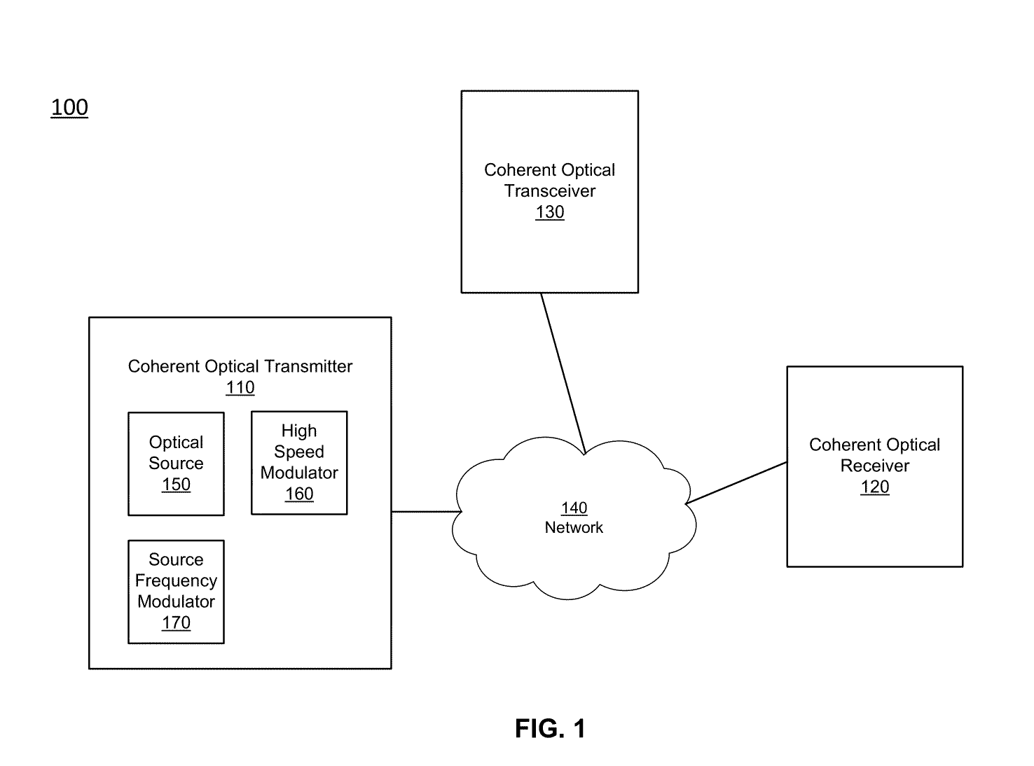

FIG. 1 is a high-level block diagram of an example communication system 100 according to an embodiment. The communication system 100 may include a coherent optical transmitter 110, a coherent optical receiver 120, and a coherent optical transceiver 130, or some other combination thereof, connected via a network 140. Here only one coherent optical transmitter 110, coherent optical receiver 120, and coherent optical transceiver 130 are illustrated, but there may be multiple instances of each of these entities in communication system 100.

The network 140 provides a communication infrastructure between the coherent optical transmitter 110, the coherent optical receiver 120, and the coherent optical transceiver 130. The network 140 is an optical network. In some embodiments, the network 140 may be implemented as, e.g., a Local Area Network (LAN), a Metropolitan Area Network (MAN), a Wide Area Network (WAN).

The coherent optical transmitter 110 modulates an optical signal with an electronic data signal and a carrier frequency of the optical signal with an electronic admin signal to create a modulated optical signal. The electronic admin signal is a slow signal. In some embodiments, electronic admin signal uses different frequencies, f₁ and f₂ to represent a logical “0” and a logical “1,” or vice versa. In some embodiments, the different frequencies are selected based on the baud rate (e.g., ˜10× baud rate). For example, for a 1 kb/s electronic admin signal f₁ may be 10 kHz and f₂ may be 11 kHz. The coherent optical transmitter 110 includes an optical source 150, a high speed modulator 160, and a source frequency modulator 170.

The optical source 150 is a laser source used to produce one or more source beams of optical radiation at a particular carrier frequency. To produce the source beam(s), the optical source 150 may include one or more laser chips (e.g., laser diodes). Additionally, one or more of the laser chips may be composed of a plurality of sections. For example, the optical source 150 may contain a single monolithic laser chip composed of a plurality of sections. The sections are different parts of the laser chip, e.g., the gain media, tuning, phase, amplifier, etc. The one or more laser chips may be chosen to produce frequencies of optical radiation useful for particular applications. For example, for some telecommunication applications, the frequencies of the optical radiation produced by the one or more laser chips may be spread across the C-band. Additionally, the optical source 150 may vary the frequency of a source beam in accordance with instructions from the source frequency modulator 170. For example, the optical source 150 may dynamically vary the carrier frequency of the source beam, within a particular modulation range, based on the slow frequencies (i.e., f₁ and f₂) of the electronic admin signal. The nominal carrier frequency is the frequency of the source beam produced by the optical source 150 if no carrier frequency modulation is occurring. In some embodiments, the nominal carrier frequency is 193.2 THz, however, in other embodiments it may be other values. The amount of modulation (i.e., modulation range) is generally close enough to the nominal carrier frequency to have minimal impact on the bit error rate at the receiver. For example, the modulation range may be within ±10 MHz, respectively, of the nominal carrier frequency.

The high speed modulator 160 modulates the source beam with an electronic data signal to create a high speed data signal. The high speed modulator 160 may be, for example, a Mach-Zehnder Modulator or some other device capable of modulating the optical signal.

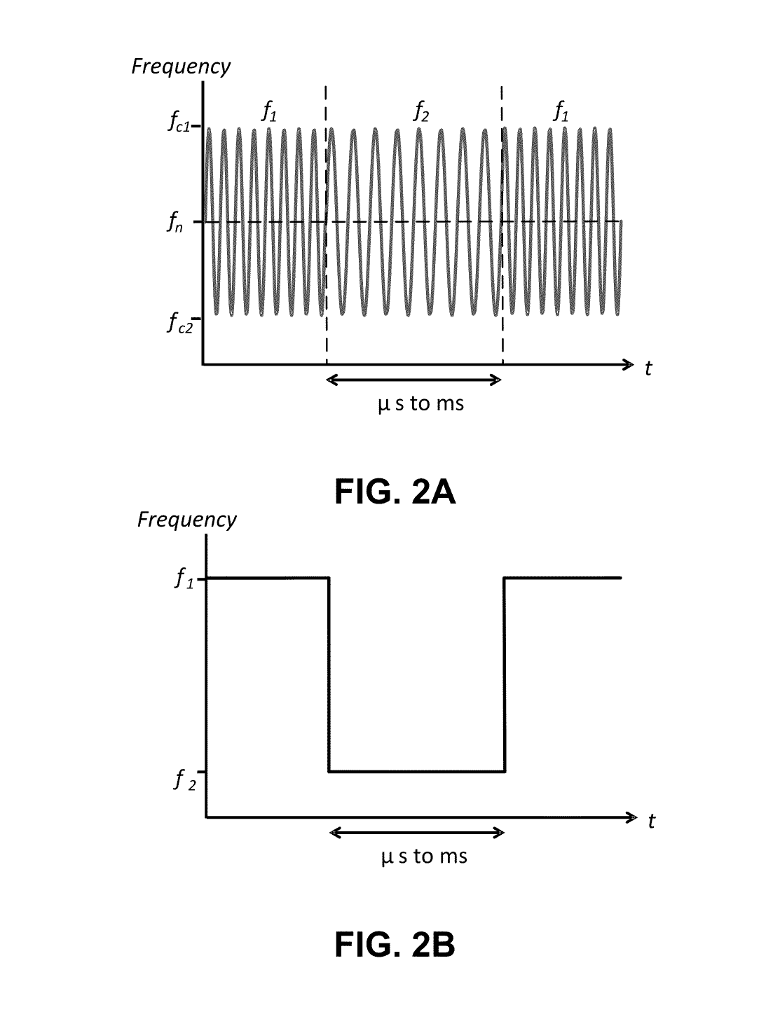

The source frequency modulator 170 modulates the carrier frequency of the source beam with the electronic admin signal to create a slow admin signal. The source frequency modulator 170 modulates the carrier frequency in accordance with the slow frequencies. In modulating the frequency of the optical carrier signal with the electronic admin signal, the source frequency modulator 170 changes the carrier frequency of the source beam at a rate much lower than value of the carrier frequency. This is discussed in detail below with reference to FIGS. 2A and 2B. The source frequency modulator 170 may modulate the carrier frequency of the source beam according to the electronic admin signal prior to, or after, the source beam has been modulated according to the electronic data signal to create a modulated optical signal. In some embodiments, the source frequency modulator 170 may modulate the carrier frequency of the source beam according to the electronic admin signal regardless of whether the source beam has been modulated according to the electronic data signal to create the modulated optical signal.

The coherent optical transmitter 110 is configured to transmit a modulated optical signal that includes the high speed data signal, the slow admin signal, or both, to one or more coherent optical receivers 120, one or more coherent optical transceivers 130, or some combination thereof.

In one embodiment, the optical source 150 may emit a source beam with at a frequency of 193.2 THz (i.e., the nominal carrier frequency) which corresponds to a wavelength of about 1.55 μm. The source frequency modulator 170 is configured to modulate the source beam based on the slow frequency values (e.g., f₁ may equal 10 kHz and f₂ may equal 11 kHz) of the electronic admin signal, with the modulation range being ±2 MHz The change in frequency associated with the modulation range is about 10⁻⁸ of the carrier frequency.

In a 10 to 100 Gb/s optical communications system, the continuous wave output of a source beam produced by optical source 150 may be modulated in both amplitude and phase to represent data. But the source frequency modulator 170 changes the carrier frequency of the source beam output from the optical source 150 on a time scale of microseconds to milliseconds, an extremely long time compared to the reciprocal of the data modulation rate which is in the picosecond regime. Thus the slow frequency modulation of the source beam may be ignored in any consideration of the high speed data carrying characteristics of a 10 to 100 Gb/s system.

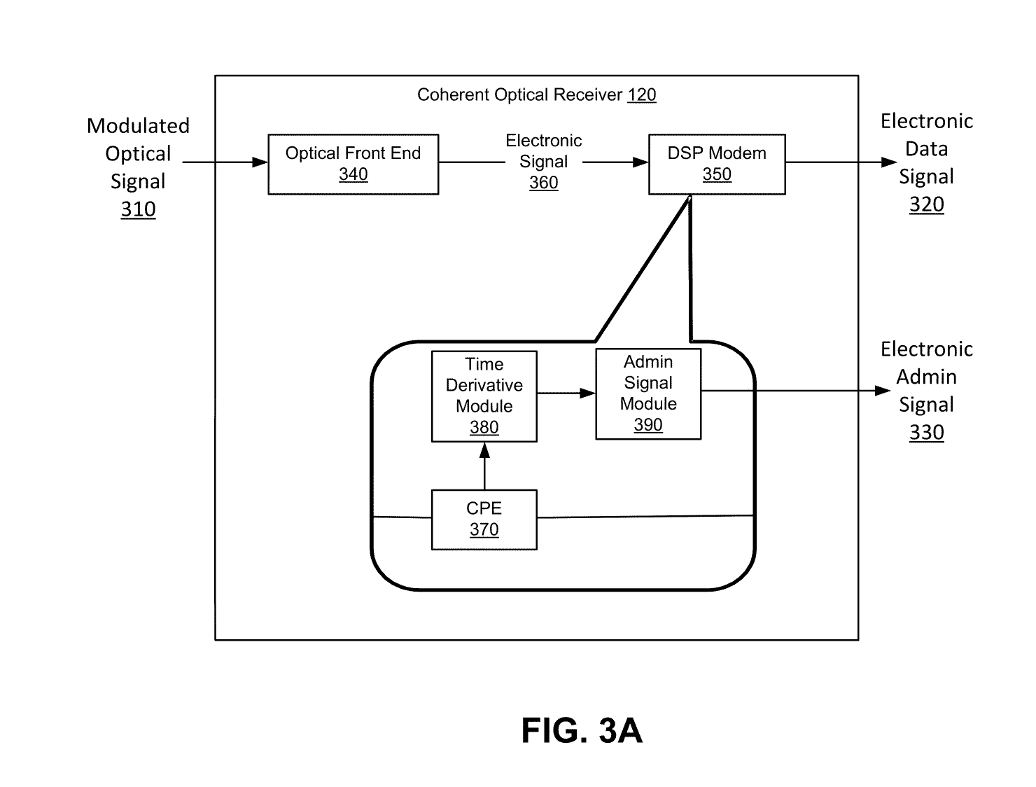

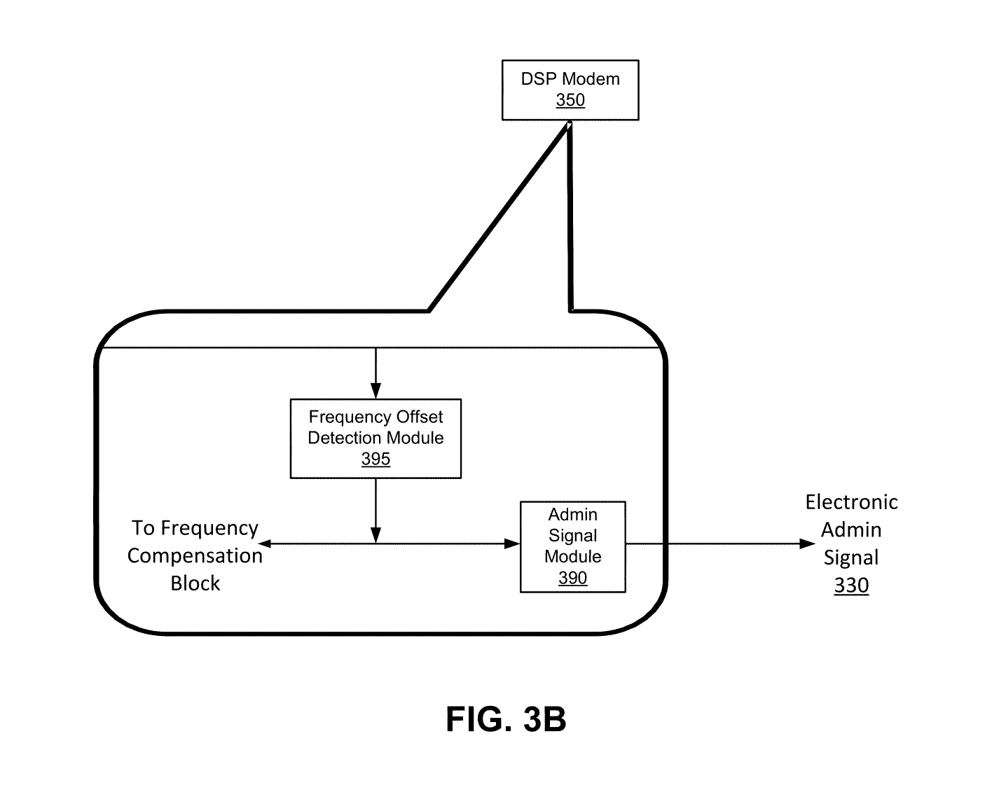

The coherent optical receiver 120 is configured to convert the modulated optical signal into information corresponding to the electronic data signal, information corresponding to the electronic admin signal, or both. The coherent optical receiver 120 includes, e.g., an optical front end, a digital signal processing (DSP) modem, and other subsystems. The operation of the coherent optical receiver 120 is discussed in detail below in conjunction with FIGS. 3A and 3B.

The coherent optical transceiver 130 is a device that includes the structure and functionality of the coherent optical transmitter 110 and the coherent optical receiver 120. Thus, the coherent optical transceiver 130 is capable of creating and transmitting an optical output signal using an electronic data signal and electronic admin signal, and receiving and translating a received modulated optical signal into its associated electronic data signal and electronic admin signal.

FIG. 2A shows an example slow admin signal according to an embodiment. The graph shows the carrier frequency of a laser beam, such as the source beam produced by optical source 150, as modified by a frequency input, such as source frequency modulator 170. The modulation range in FIG. 2A is constant, and varies between an upper frequency level (f_{c1}) and a lower frequency level (f_{c2})—the difference of which is the modulation range. FIG. 2A does not show amplitude of the source beam—which is constant. In the part of the graph marked f_{1,} the carrier frequency of the laser beam varies between f_{c1} and f_{c2} at a slow frequency (i.e. f₁) associated with the electronic admin signal. Similarly, in the part of the graph marked f_{2,} the carrier frequency of the laser beam varies between f_{c1} and f_{c2} at a different slow frequency (i.e., f₂) associated with the electronic admin signal. The durations of times when the frequency of the optical source is f₁ or f₂ are in the microsecond to millisecond range. In one embodiment, the nominal carrier frequency is 193.2 THz, f_{c1} is 193,200,002 MHz, f_{c2} is 193,199,998 MHz, f₁ is 10 kHz, and f₂ is 11 kHz.

FIG. 2B shows the slow admin signal 200 of FIG. 2A in terms of frequency versus time according to an embodiment. The graph shows the output frequency of a laser beam, such as optical source 150, as modified by a frequency input, such as source frequency modulator 170. A high-speed, coherent optical data receiver, such as coherent optical receiver 120, can track the carrier frequency of a received data signal while simultaneously performing all its other detection and demodulation functions. As an example of slow speed signaling, laser carrier frequency variation at f₁ may be assigned logical “0” and laser carrier frequency variation at f₂ may be assigned logical “1” for sending digital messages, or vice versa. The data rate of these messages is no more than several hundred kb/s. That is sufficient however for transmitting channel supervisory or identification information over a coherent optical data link (e.g., network 140) without affecting high-speed data transmission characteristics of the link.

FIG. 3A is a block diagram of an example coherent optical receiver 120 according to an embodiment. The coherent optical receiver 120 is configured to convert the modulated optical signal 310 into information corresponding to an electronic data signal 320, information corresponding to an electronic admin signal 330, or both. The coherent optical receiver 120 includes an optical front end 340 and a digital signal processing (DSP) modem 350. In some embodiments, the coherent optical receiver 120 may include other subsystems.

The optical front end 340 converts the modulated optical signal 310 to an electronic signal 360. The optical front end 340 may include an optical mixer, one or more photodetectors (e.g., p-i-n diodes), one or more amplifiers (e.g., trans-impedance amplifiers), one or more polarized beam splitters, a local oscillator, associated sub-systems, or some combination thereof. The optical front end 340 may be configured in a variety of ways so long as it converts the modulated optical signal 310 into the electronic signal 360. Additionally, in embodiments, where the modulated optical signal 310 is composed of multiple channels, the optical front end 340 is configured to select (e.g., tuning the local oscillator to the frequency of the desired channel) a desired channel from the modulated optical signal 310. Ideally, the optical front end 340 removes the carrier frequency from the modulated optical signal 310, however, in reality the carrier frequencies of the local oscillator and the modulation optical signal 310 differ (e.g., frequency drift, carrier frequency modulation, etc.). Accordingly, there is a difference frequency component that is part of the electronic signal 360, where the difference frequency component is the difference in carrier frequency between the modulated optical signal 310 and the local oscillator. The information corresponding to the electronic admin signal 330 is described by changes in the frequency of modulation (i.e., the slow frequencies f₁ and f₂) of the electronic signal 360.

The DSP modem 350 processes the electronic signal 360 to output information corresponding to the electronic data signal 320, information corresponding to the electronic admin signal 330, or both, depending on the content of the electronic signal 360. The DSP modem 350 includes a carrier phase estimator (CPE) 370, a time derivative module 380, an admin signal module 390, and may additionally include one or more modules for analog-to-digital conversion, chromatic dispersion compensation, timing recovery, equalization, slicing, forward error correction, other functions, or some combination thereof. The DSP modem 350 conducts high speed demodulation operations on the electronic signal 360 to extract information corresponding to the electronic data signal 320.

As depicted in the callout symbol, the CPE 370 estimates an average phase of a carrier of the selected signal by averaging the phase over many symbol intervals that correspond to a particular time interval in the electronic signal 360. The time interval may correspond to, for example, 3 to 100 symbols of data.

The time derivative module 380 takes the time derivative of the estimated carrier phase to determine an offset value proportional to the frequency offset component. The time derivative module 380 takes a time derivative for each time interval that the carrier phase is estimated to determine an associated offset value. The frequency of the offset value generally corresponds to a particular slow frequency (e.g., f₁, or f₂). The time derivative module 380 outputs the offset values to the admin signal module 290.

Additionally, in some embodiments, the time derivative module 380 may output the offset values to a frequency compensation block (not shown). The frequency compensation block may utilize the offset values to compensate for differences between the carrier frequency of the received modulated optical signal 310 and the local oscillator.

The admin signal module 390 extracts information corresponding to the electronic admin signal using the determined offset values. Specifically, the admin signal module 390 detects changes between the frequencies of the received offset values to determine which slow frequency (i.e., logical 0 or 1) is associated with each offset value, and extracts the corresponding electronic admin signal. The slow (kHz) extraction of the electronic admin signal operates simultaneously with the high speed (GHz) demodulation operations performed by DSP modem 350 to obtain the electronic data signal 320. Thus the carrier phase estimator 370 is used as a kind of discriminator in a frequency modulation receiver. Accordingly, the time derivative module 380 is able to easily determine the plurality of slow frequencies associated with different estimated carrier phases.

FIG. 3B is a block diagram of portion of an example DSP modem 350 according to an embodiment. In this embodiment, the DSP modem 350 includes a frequency offset detection module 395 that is configured to detect the offset values in lieu of the CPE 370 and time derivative module 380 described above with reference to FIG. 3A. The offset values may then be provided to a frequency compensation module (not shown) and the admin signal module 390.

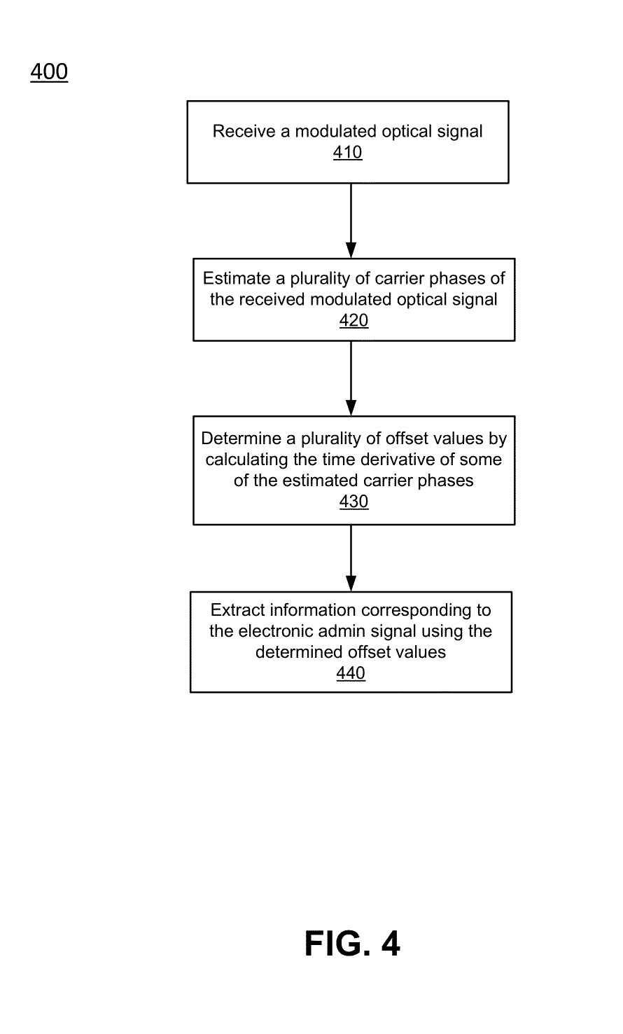

FIG. 4 is an example process 400 for detecting carrier frequency changes in a coherent optical receiver 120 according to an embodiment. The coherent optical receiver 120 receives 410 a modulated optical signal 310 from a coherent optical transmitter, the coherent optical transmitter having modulated a nominal carrier frequency of the modulated optical signal using a first slow frequency and second slow frequency associated with an electronic admin signal, and the amount of modulation not exceeding a modulation range. Additionally, in some embodiments, the modulated optical signal 130 may include a high speed data signal. The coherent optical receiver 120 converts the received modulated optical signal 310 into an electronic signal 360.

The coherent optical receiver 120 estimates 420 a plurality of carrier phases of the optical modulated optical signal 310 using the electronic signal 360. The coherent optical receiver 120 estimates the carrier phase over particular time intervals (e.g., corresponding to a certain number of received symbols). Thus, each time interval has an associated estimated carrier phase.

The coherent optical receiver 120 determines 430 a plurality of offset values by calculating the time derivative of some of the estimated carrier phases. Each offset value is proportional to a frequency offset component representative of the difference in carrier frequencies between the modulated optical signal and a local oscillator in the coherent optical receiver 120. The coherent optical receiver 120 calculates the time derivative for all of the estimated carrier phases. Specifically, the coherent optical receiver 120 takes a time derivative of the estimated carrier phase associated with a particular time interval to determine an offset value associated with the particular time interval.

The coherent optical receiver 120 extracts 440 information corresponding to the electronic admin signal using the determined plurality of offset values. Specifically, the coherent optical receiver 120 detects changes between the frequencies of the received offset values to determine which slow frequency is associated with each offset value, and extracts the corresponding electronic admin signal. The slow frequencies may be the first slow frequency or the second slow frequency. These are the fundamental operations performed in a DSP modem like DSP modem 310 to decode a slow speed signal as shown and explained in connection with FIG. 2. Accordingly, no additional hardware is needed to extract the information corresponding to the electronic admin signal. In some embodiments, the extraction of information corresponding to the electronic admin signal occurs concurrent with the high speed extraction of information corresponding to the electronic data signal.

The data signaling scheme described above may be used by coherent optical transceiver operators to send electronic admin data like, e.g., supervisory or channel identification data without interfering with, or depending on knowledge of, high speed data transmission. A 193.2 THz laser carrier frequency varying by ±2 MHz has been used as an example. Clearly other laser frequencies and frequency deviations are acceptable.

### Additional Configuration Considerations

The foregoing description of the embodiments has been presented for the purpose of illustration; it is not intended to be exhaustive or to limit the disclosure to the precise forms disclosed. Persons skilled in the relevant art can appreciate that many modifications and variations are possible in light of the above disclosure.

Any of the steps, operations, or processes described herein may be performed or implemented with one or more hardware or software modules, alone or in combination with other devices. In one embodiment, a software module is implemented with a computer program product comprising a computer-readable medium containing computer program code, which can be executed by a computer processor for performing any or all of the steps, operations, or processes described.

Embodiments may also relate to an apparatus for performing the operations herein. This apparatus may be specially constructed for the required purposes, and/or it may comprise a general-purpose computing device selectively activated or reconfigured by a computer program stored in the computer. Such a computer program may be stored in a non transitory, tangible computer readable storage medium, or any type of media suitable for storing electronic instructions, which may be coupled to a computer system bus. Furthermore, any computing systems referred to in the specification may include a single processor or may be architectures employing multiple processor designs for increased computing capability.

Additionally, the language used in the specification has been principally selected for readability and instructional purposes, and it may not have been selected to delineate or circumscribe the inventive subject matter. It is therefore intended that the scope of the embodiments be limited not by this detailed description, but rather by any claims that issue on an application based hereon. Accordingly, the disclosure of the embodiments is intended to be illustrative, but not limiting, of the scope of the disclosure, which is set forth in the following claims.

Finally, in the claims, reference to an element in the singular is not intended to mean “one and only one” unless explicitly stated, but rather is meant to mean “one or more.” In addition, it is not necessary for a device or method to address every problem that is solvable by different embodiments of the invention in order to be encompassed by the claims.

1. A method comprising:
receiving, at a coherent optical receiver, a modulated optical signal sent by a coherent optical transmitter, wherein
the modulated optical signal includes a high speed data signal, and the coherent optical transmitter modulated a nominal carrier frequency of the modulated optical signal using a first slow frequency and second slow frequency associated with an electronic admin signal;
converting the modulated optical signal to an electronic signal that includes a plurality of frequency offset components;
estimating a plurality of carrier phases of the electronic signal;
determining a plurality of offset values by calculating the time derivative of at least some of the estimated carrier phases, wherein each of the plurality of offset values are proportional to an associated frequency offset component, of the plurality of frequency offset components, and the frequency of each offset value corresponds to the first slow frequency or the second slow frequency; and
extracting information corresponding to the electronic admin signal using the determined plurality of offset values.

2. The method of claim 1, wherein the nominal carrier frequency is 193.2 THz.

3. The method of claim 2, wherein the amount of modulation that the coherent optical transmitter uses to modulate the nominal carrier frequency using the electronic admin signal is within ±200 MHz of the nominal carrier frequency.

4. The method of claim 1, wherein the minimum duration of the first slow frequency and the second slow frequency is between 0.1 μs and 1 ms.

5. The method of claim 1, further comprising:
extracting information corresponding to the high speed data signal from the electronic signal.

6. The method of claim 5, wherein the information corresponding to the high speed data signal has bit rate of at least 10 Gb/s and the information corresponding to the slow speed admin signal has a bit rate of no more than several hundred kb/s.

7. The method of claim 1, wherein the first slow frequency corresponds to a logical “0” and the second slow frequency corresponds to a logical “1.”

8. The method of claim 7, wherein the first slow frequency equals 10 kHz, and the second slow frequency equals 11 kHz.

9. The method of claim 1, wherein estimating the plurality of carrier phases occurs over a plurality of timing intervals, wherein the duration of each timing interval is the same, and determining a plurality of slow frequencies by calculating the time derivative of the estimated carrier phase, further comprises:
calculating a time derivative of estimated carrier phase for each time interval to obtain an offset value associated with each time interval.

10. A method comprising:
modulating, via a coherent optical transmitter, a laser beam from an optical source to create a modulated optical signal, wherein the modulated optical signal includes a high speed data signal, and the coherent optical transmitter also modulates a nominal carrier frequency of the modulated optical signal using an electronic admin signal using a first slow frequency and second slow frequency associated with the electronic admin signal;
transmitting, by the coherent optical transmitter, the modulated optical signal to a coherent optical receiver via an optical network;
receiving, at a coherent optical receiver, the modulated optical signal;
converting the modulated optical signal to an electronic signal that includes a plurality of frequency offset components;
estimating the carrier phase of the electronic signal;
determining a plurality of offset values by calculating the time derivative of the estimated carrier phase, wherein each of the plurality of offset values are proportional to an associated frequency offset component, of the plurality of frequency offset components, and the frequency of each offset value corresponds to the first slow frequency or the second slow frequency; and
extracting information corresponding to the electronic admin signal using the determined plurality of offset values.

11. The method of claim 10, wherein the nominal carrier frequency is 193.2 THz.

12. The method of claim 11, wherein the amount of modulation that the coherent optical transmitter uses to modulate the nominal carrier frequency using the electronic admin signal is within ±200 MHz of the nominal carrier frequency.

13. The method of claim 10, wherein the minimum duration of the first slow frequency and the second slow frequency is between 0.1 μs and 1 ms.

14. The method of claim 10, further comprising:
extracting information corresponding to the high speed data signal from the electronic signal.

15. The method of claim 14, wherein the information corresponding to the high speed data signal has bit rate of at least 10 Gb/s and the information corresponding to the slow speed admin signal has a bit rate of no more than several hundred kb/s.

16. The method of claim 10, wherein the first slow frequency corresponds to a logical “0” and the second slow frequency corresponds to a logical “1.”

17. The method of claim 16, wherein the first slow frequency equals 10 kHz, and the second slow frequency equals 11 kHz.

18. The method of claim 10, wherein estimating the carrier phase of the electronic signal occurs over a plurality of timing intervals, wherein the duration of each timing interval is the same, and determining a plurality of offset values by calculating the time derivative of the estimated carrier phase, further comprises:
calculating a time derivative of estimated carrier phase for each time interval to obtain an offset value associated with each time interval.

19. A transceiver comprising:
a coherent optical transmitter including:
an optical source configured to generate a laser beam at a carrier frequency,
a high speed modulator configured to modulate the laser beam with an electronic data signal to create a high speed data signal,
a source frequency modulator configured to modulate the carrier frequency of the laser beam using an electronic admin signal to include a slow admin signal using a first slow frequency and second slow frequency associated with the electronic admin signal, and the amount of modulation does not exceed a modulation range,
wherein, the coherent optical transmitter is configured to transmit a first modulated optical signal that includes the high speed data signal and the first slow admin signal to a first coherent optical receiver via an optical network; and
a second coherent optical receiver, includes:
an optical front end configured to:
receive a second modulated optical signal from a second coherent optical transmitter, wherein the second modulated optical signal includes a second high speed data signal, and a carrier frequency of the second modulated optical signal was modulated using a second electronic admin signal using the first slow frequency and the second slow frequency associated with the second electronic admin signal, and
convert the second modulated optical signal to a second electronic signal that includes a plurality of frequency offset components, and
a digital signal processing modem configured to:
estimate the carrier phase of the electronic signal,
determine a plurality of offset values by calculating the time derivative of the estimated carrier phase, wherein each of the plurality of offset values are proportional to an associated frequency offset component, of the plurality of frequency offset components, and the frequency of each offset value corresponds to the first slow frequency or the second slow frequency, and
extract information corresponding to the second electronic admin signal using the determined plurality of offset values.

20. The transceiver of claim 19, wherein the modulation range is within ±200 MHz of the nominal carrier frequency.
